(19) United States
(12) Patent Application Publication
(10) Pub. No.: US 2026/0220824 A1
(43) Pub. Date: Jul. 30, 2026

(54) A METHOD AND AN APPARATUS FOR ENCODING/DECODING AT LEAST ONE PART OF AN IMAGE USING ONE OR MORE MULTI-RESOLUTION TRANSFORM BLOCKS

(71) Applicant: InterDigital VC Holdings, Inc., Wilmington, DE (US)

(72) Inventors: Syed Mateen UL HAQ, Mountain View, CA (US); Fabien RACAPE, SAN FRANCISCO, CA (US); Hyomin CHOI, Sunnyvale, CA (US); Wei JIANG, Sunnyvale, CA (US)

(21) Appl. No.: 19/152,340

(22) PCT Filed: Jan. 30, 2024
(86) PCT No.: PCT/US2024/013566

§ 371 Date: Jul. 30, 2025

Related U.S. Application Data
(60) Provisional application No. 63/442,878, filed on Feb. 2, 2023.

(51) Int. Cl. G06T 9/00; G06N 3/0455; G06N 3/0464; G06T 3/4046

(52) U.S. Cl. CPC G06T 9/002; G06N 3/0455; G06N 3/0464; G06T 3/4046

(57) ABSTRACT

Methods and apparatuses for encoding/decoding at least one part of an image using one or more multi-resolution transform blocks are disclosed, wherein a multi-resolution transform block applies one or more convolution operations to an input to the multi-resolution transform block at different resolutions. In some embodiments, the multi-resolution transform block comprises a first convolution layer applied to the input, at least one down-sampling of the input, at least one second convolution layer applied to the at least one down-sampled input, at least one up-sampling of an output of the at least one second convolution layer, a combination of the at least one up-sampled output and an output of the first convolution layer.

### CROSS REFERENCE TO RELATED APPLICATIONS

This application claims the priority to U.S. Patent Application No. 63/442,878, filed on 2 Feb. 2023, which is incorporated herein by reference in its entirety.

### TECHNICAL FIELD

At least one of the present embodiments generally relates to a method or an apparatus for compression of images and videos using Neural Network (NN) based tools.

### BACKGROUND

In recent years, deep Neural Networks have been developed to surpass the compression performance of traditional codecs. For instance, the Joint Video Exploration Team (JVET) between ISO/MPEG and ITU is currently studying such tools to replace some modules of the latest standard H.266/VVC, as well as the replacement of the whole structure by end-to-end auto-encoder methods.

More precisely, different approaches can be distinguished. Purely encoder methods can be seen as NN-based algorithms that are used to enhance or speed-up an encoder of an existing codec. In that case, there is no normative change, any existing standard can be used. Methods that are built on top of existing standards replaces one or more modules of existing state-of-the-art codecs with NN-based methods, e.g., post-filters, prediction modules, etc. End-to-end NN-based codecs are completed disrupted from traditional compression schemes that include prediction, transform, quantization and entropy coding modules.

Contrary to traditional methods which apply pre-defined prediction modes and transforms, NN-based methods rely on many parameters that are learned on a large dataset during a training stage, by iteratively minimizing a loss function. In the case of image and video compression, the loss function is defined by a rate-distortion cost, where the rate stands for an estimation of a bitrate of an encoded bitstream, and the distortion quantifies a quality of a decoded video against an original input. Traditionally, the quality of the decoded input image is optimized, for example, based on the measure of the mean squared error or an approximation of the human-perceived visual quality. Usually, end-to-end NN-based codecs comprise one or more convolution operations. Convolutions are locally windowed operations that are often limited to 3×3 or 5×5 sized windows for practical reasons. Using larger kernels in the convolution operations would facilitate the development of models that are better at detecting large-scale and small-scale patterns and determining possible compression related tradeoffs among them. Large convolution kernel sizes of e.g. 21×21 are one way to obtain larger context windows. However, with large kernels, the trained model becomes more prone to overfitting since the number of degrees of freedom is an order of magnitude larger and the computational burden is much heavier since the computational cost of a convolution is proportional to the number of elements in the kernel.

### SUMMARY

At least one of the present embodiments generally relates to a method or an apparatus in the context of the compression of images and videos using neural networks.

At least one of the present embodiments generally relates to a transform block configured to apply convolution operations at different resolutions of an input tensor.

Some embodiments relate to a method for processing data input to a neural network, wherein the neural network comprises at least one multi-resolution transform block. Some embodiments relate to a method for encoding at least one part of an image using a neural network, the neural network comprising at least one multi-resolution transform block. Some embodiments relate to a method for decoding a latent representative of at least one part of an image, wherein decoding the latent uses a neural network that comprises at least one multi-resolution transform block.

In some embodiments, the multi-resolution transform block comprises one or more convolution operations applied to an input to the multi-resolution transform block at different resolutions.

In some embodiments, the multi-resolution transform block comprises a first convolution layer applied to the input, at least one down-sampling of the input, at least one second convolution layer applied to the at least one down-sampled input, at least one up-sampling of an output of the at least one second convolution layer, a combination of the at least one up-sampled output and an output of the first convolution layer.

According to another aspect, there is provided an apparatus. The apparatus comprises a processor. The processor can be configured to implement the general aspects by executing any of the described methods. According to another general aspect of at least one embodiment, there is provided a device comprising an apparatus configured to implement the general aspects by executing any of the described embodiments; and at least one of (i) an antenna configured to receive a signal, the signal including a video or an image, (ii) a band limiter configured to limit the received signal to a band of frequencies that includes the video or image, or (iii) a display configured to display an output representative of the video or image.

According to another general aspect of at least one embodiment, there is provided a computer program product comprising instructions which, when the program is executed by a computer, cause the computer to carry out any of the embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates a block diagram of a system within which aspects of the present embodiments may be implemented.

FIG. 2 illustrates a block diagram of an embodiment of an auto-encoder for image or video compression.

FIG. 3 illustrates a block diagram of an embodiment of a training of an auto-encoder for image or video compression.

FIG. 4 illustrates a block diagram of an embodiment of an auto-encoder with a hyperprior architecture.

FIG. 5 illustrates an example of effective window sizes for 5×5 convolution applied after application of 1×, 2× and 4× downscales.

FIG. 6 illustrates an embodiment of a method for processing data using one or more multi-resolution transform blocks.

FIG. 7 illustrates another embodiment of a method for processing data using one or more multi-resolution transform blocks.

FIG. 8 illustrates a block diagram of an embodiment of a multi-resolution transform block.

FIG. 9 illustrates a block diagram of another embodiment of a multi-resolution transform block.

FIG. 10 illustrates a block diagram of another embodiment of a multi-resolution transform block.

FIG. 11 illustrates a block diagram of another embodiment of a multi-resolution transform block.

FIG. 12 illustrates a block diagram of another embodiment of a multi-resolution transform block.

FIG. 13 illustrates a block diagram of an embodiment of an image or video encoder based on neural network using one or more multi-resolution transform block.

FIG. 14 illustrates a block diagram of an embodiment of an image or video decoder based on neural network using one or more multi-resolution transform block.

FIG. 15 illustrates one embodiment of an apparatus for encoding or decoding an image or a video according to any one of the embodiments described herein.

FIG. 16 shows two remote devices communicating over a communication network in accordance with an example of present principles.

FIG. 17 shows the syntax of a signal in accordance with an example of present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

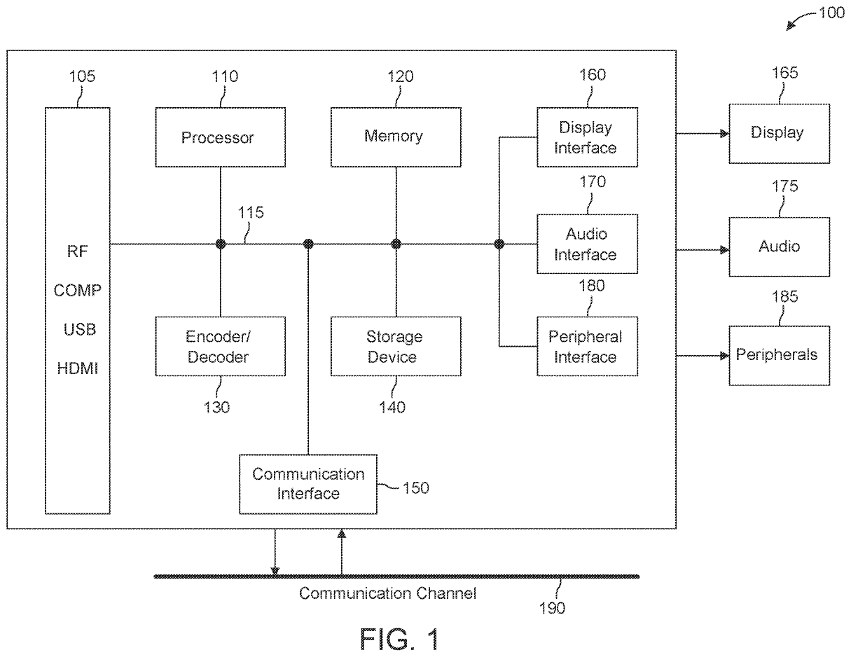

The aspects described and contemplated in this application can be implemented in many different forms. FIGS. 1-17 below provide some embodiments, but other embodiments are contemplated and the discussion of FIGS. 1-17 does not limit the breadth of the implementations. At least one of the aspects generally relates to image or video encoding and decoding, and at least one other aspect generally relates to transmitting a bitstream generated or encoded. These and other aspects can be implemented as a method, an apparatus, a computer readable storage medium having stored thereon instructions for encoding or decoding image or video data according to any one of the methods described, and/or a computer readable storage medium having stored thereon a bitstream generated according to any one of the methods described.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

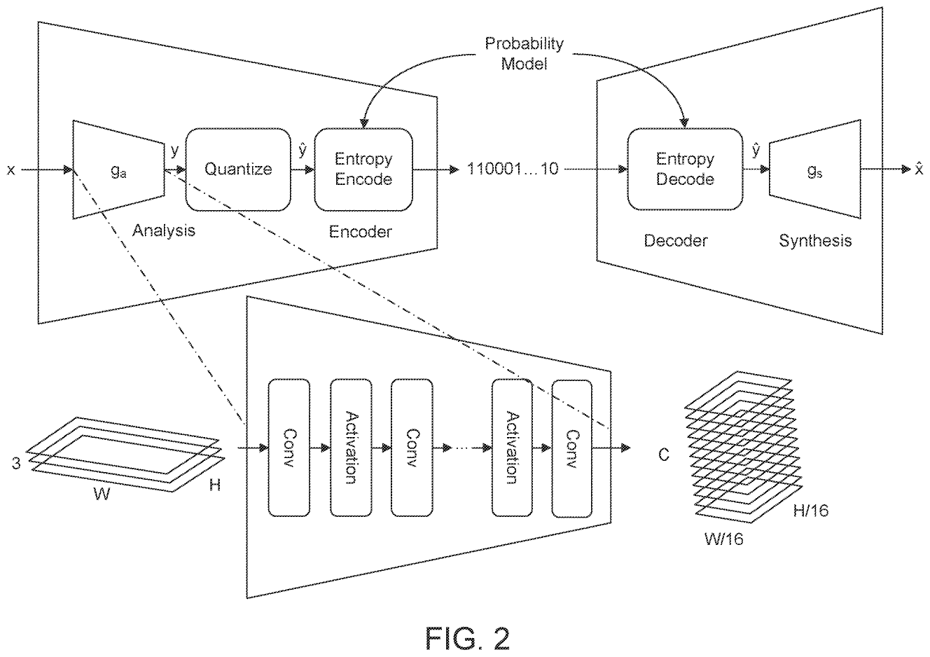

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art. In some embodiments, the encoder/decoder module 130 is a NN-based auto-encoder, e.g. an auto-encoder or a variational auto-encoder described in relation with FIG. 2-4, and implements one or more embodiments transform block as further described below. In the present document, the transform block described in the embodiments is called multi-resolution transform block for clarity, other wording can be used without limiting the scope of the embodiments described herein.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device can be either the processor 110 or the encoder/decoder module 130) is used for one or more of these functions. The external memory can be the memory 120 and/or the storage device 140, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations.

The input to the elements of system 100 can be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data-stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the Inter-IC (I2C) bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed, or otherwise provided, to the system 100, in various embodiments, using a wireless network such as a Wi-Fi network, for example IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 can provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 1100 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, Consumer Electronics Control (CEC), or other communications protocols that enable device-to-device control with or without user intervention. The output devices can be communicatively coupled to system 100 via dedicated connections through respective interfaces 160, 170, and 180. Alternatively, the output devices can be connected to system 100 using the communications channel 190 via the communications interface 150. The display 165 and speakers 175 can be integrated in a single unit with the other components of system 100 in an electronic device such as, for example, a television. In various embodiments, the display interface 160 includes a display driver, such as, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, digital signal processors (DSPs), and processors based on a single or on a multi-core architecture, sequential or parallel architectures, specialized circuits such as Field Programmable gate arrays (FPGA), application specific circuits (ASIC), signal processing devices and other processing circuitry, as non-limiting examples.

In the present application, the terms “reconstructed” and “decoded” may be used interchangeably, the terms “encoded” or “coded” may be used interchangeably, the terms “pixel” or “sample” may be used interchangeably, and the terms “image,” “picture” and “frame” may be used interchangeably. Usually, but not necessarily, the term “reconstructed” is used at the encoder side while “decoded” is used at the decoder side.

FIG. 2 illustrates an embodiment of an end-to-end compression system wherein one or more embodiments of a multi-resolution transform block described below can be implemented. The input x to the encoder part of the network can consists of an image or frame of a video, or a part of an image, or a tensor representing a group of images, or a tensor representing a part (crop) of a group of images. In each case, the input can have one or multiple components, e.g.: monochrome, RGB or YCbCr components. In the example of FIG. 2, the input x has 3 components of size HxW respectively.

The input x is fed into the encoder network gₐ, also known as analysis transform. The analysis transform gₐ is usually a sequence of convolutional layers (Conv in FIG. 2) with activation functions (Activation in FIG. 2). The convolutions can include a mechanism to spatially down-sample the input, for instance selecting a convolution with a stride of 2 in both vertical and horizontal directions would result in an output having half the size of the input in both dimensions. The output of a convolution is a tensor of shape C×H×W, where H and W are the spatial height and width, respectively, and C corresponds to an adjustable number of channels. For an RGB image for instance, a first convolution of gₐ takes as input a tensor of 3 channels which correspond to the color components. This encoder network can be seen as a learned transform, that is lossy as there are generally fewer elements in the output latent tensor than the source 3×H×W input. The output of the analysis, mostly in the form of a 3-way array, referred to as a 3-D tensor, is called a latent representation or a tensor of latent variables. From a broader perspective, a set of latent variables constructs a latent space, which is also frequently used in the context of neural network-based end-to-end compression. The output y=gₐ(x) is quantized, resulting in a tensor ŷ which is then entropy coded into a binary stream (bitstream) for storage or transmission.

At the decoder, the bitstream is entropy decoded (ED) to obtain ŷ. The decoder network gₛ, also called synthesis transform, generates the reconstructed input: \hat{x}=gₛ(y), which is an approximation of the original x from the quantized latent representation ŷ. The synthesis transform gₛ is usually a sequence of up-sampling convolutions, e.g., transpose convolutions or convolutions followed by up-sampling filters. The decoder network can be seen as a learned inverse transform, or a denoising and generative transform.

The performance of a compression system is measured as a tradeoff between the number of bits needed to transmit versus the quality of the decoded content. For one of these tradeoffs, a compression model can be trained using a loss following the Lagrangian form L=R+AD, where R represents the rate or bitrate and D the distortion of the decoded content.

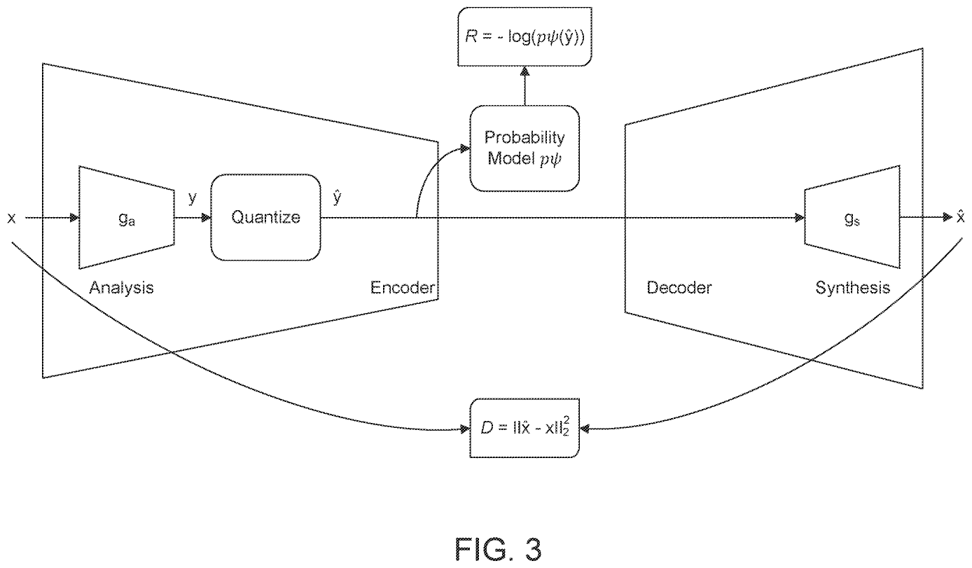

FIG. 2 and FIG. 3 show autoencoders in an actual inference configuration that consists of an encoder producing a bitstream that is then transmitted and decoded. During training, as entropy encoding/decoding is non-differentiable, the entropy of ŷ is determined with respect to a learned probability model p_{ψ}, as depicted in FIG. 3.

As for the distortion, in existing approaches, such NNs are trained using several types of losses that can be used alone or in combination. A loss based on an “objective” metric, typically Mean Squared Error (MSE), noted ∥\hat{x}−x∥₂² in FIG. 3 can be used or for instance based on structural similarity (SSIM). The results may not be perceptually as good as the second type, but the fidelity to the original signal (image) is higher. Loss based on “subjective” (or subjective by proxy) can also be used, typically using Generative Adversarial Networks (GANs) during the training stage or advanced visual metric via a proxy NN.

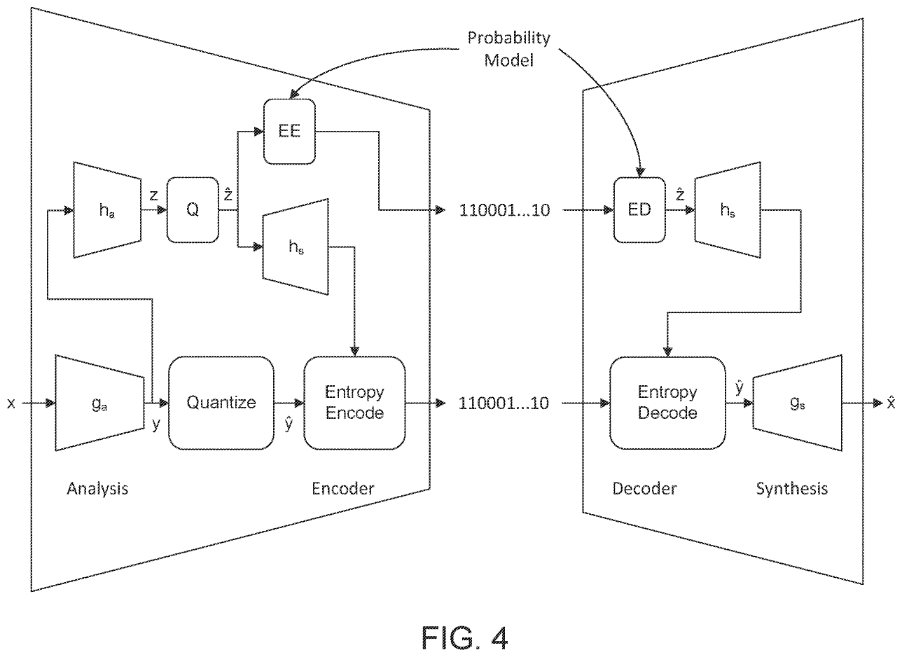

In the autoencoder presented above, the entropy encoder and decoder rely on a simple fully factorized prior, as depicted in FIG. 2. This method usually considers separate trained entropy models per channel of the latent. The spatial correlations in the latent ŷ are not considered as each of the samples are encoded using the same distribution, i.e., assuming that they are independent and identically distributed (i.i.d). However, even after the processing by gₐ, ŷ is not i.i.d and more recent approaches have taken on this specific issue. FIG. 4 depicts an approach called auto-encoder with a hyperprior, as the model now includes additional convolutional sequences hₐ and hₛ that output a learned distribution parameters for each element of the latent ŷ respectively in a latent z and \hat{z}. For example, the learned distribution parameters are the scales or means and scales of Gaussian or Laplace distributions, for each element of the latent ŷ. The tensor z output by hₐ needs to be encoded and transmitted as side information for the decoder to decode ŷ. The tensor z is thus quantized to the tensor \hat{z} and entropy encoded (EE). On the decoder side, the bitstream representing the latent \hat{z} of the quantized learned parameters is entropy decoded (ED) and fed into the synthesis transform of the distribution information hₛ.

Transmitting that tensor \hat{z} using a fully factorized approach does not cost much overhead as \hat{z} corresponds to y further downscaled by hₐ and the efficiency of using tailored gaussians for each element of the ŷ dramatically surpasses the burden of transmitting the light \hat{z}.

Note that in FIG. 4, which represent all the operations and elements necessary for the actual coding and decoding of an image, the synthesis of the distribution information hₛ appears at both the encoder and the decoder. Like in traditional video coding, the encoder contains parts of the decoder to generate the exact same metadata that the decoder will decode to process the rest of the bitstream. The synthesis hₛ must perform bit exact operations between the encoder and the decoder for the system to work. A slight difference in the generated parameters would completely crash the arithmetic decoder for ŷ.

For current NN-based compression models, large “field of vision” operations only occur after several down-samplings deep into the model. This effectively limits the learned encoder-side analysis transform gₐ to making “decisions” about global spatial redundancies within the image to the later stages of the transform. However, the ability to “see” a larger context window earlier within the encoder-side transform may facilitate the development of models that are better at detecting both large-scale and small-scale patterns and determining possible compression related tradeoffs among them.

In some embodiment, a multi-resolution transform block is proposed that is intended to provide a larger “field of vision” in comparison to a traditional simple convolution layer. Convolutions are locally windowed operations that are often limited to 3×3 or 5×5 sized windows for practical reasons. This limits the “field of vision” of a traditional convolution layer to a very small region. According to the embodiments described herein, by applying 3×3 or 5×5 convolutions upon downscaled inputs, the multi-resolution transform block can “see” a much larger context without paying the price of an equivalent large-windowed convolution. For instance, a 5×5 on a 4× downscaled input has an effective window size of approximately 20×20 as illustrated by FIG. 5 showing effective window sizes for a 5×5 convolution applied after application of 1×, 2× and 4× downscales.

Large convolution kernel sizes of e.g. 21×21 are one way to obtain larger context windows. However, with large kernels, the trained model becomes more prone to overfitting since the number of degrees of freedom is an order of magnitude larger and the computational burden is much heavier since the computational cost of a convolution is proportional to the number of elements in the kernel.

The inception module is a transform block that follows a similar parallel structure. It applies 1×1, 3×3, and 5×5 convolutions to an input provided to the transform block, and then concatenates the results together. However, convolution kernel sizes are practically limited to 5×5 due to reasons such as number of parameters, computational speed, and overfitting. This limits each block to an effective window size of 5×5.

In some embodiments proposed herein, a downscale (e.g. by 2×) is included before each of the convolutions. This allows to achieve larger effective window sizes such as 5×5, 10×10, and 20×20 for a 1×, 2×, and 4× downscale, respectively, for a 5×5 true convolution kernel size. In traditional image compression, wavelet transform can be applied repeatedly in order to recursively transform an input into a smaller and smaller resolution image. The wavelet kernels are also local, e.g. 2×2. Such methods rely upon downscaling in order to compactly represent the redundancies at a global resolution. Furthermore, once a downscale is applied, it is no longer possible to reduce the redundancy at the finer resolution.

In contrast, in the embodiments described herein, when the multi-resolution transform block substitutes the top-level (i.e. main branch) convolution blocks in the auto-encoder, the multi-resolution transform blocks can “lookahead” and reduce global redundancies earlier within the transform, prior to top-level downscales.

A method and an apparatus for processing data using one or more multiresolution transform blocks are provided herein. In some embodiments, an architecture of a compression model that can be trained end-to-end including one or more multi-resolution transform blocks is provided herein.

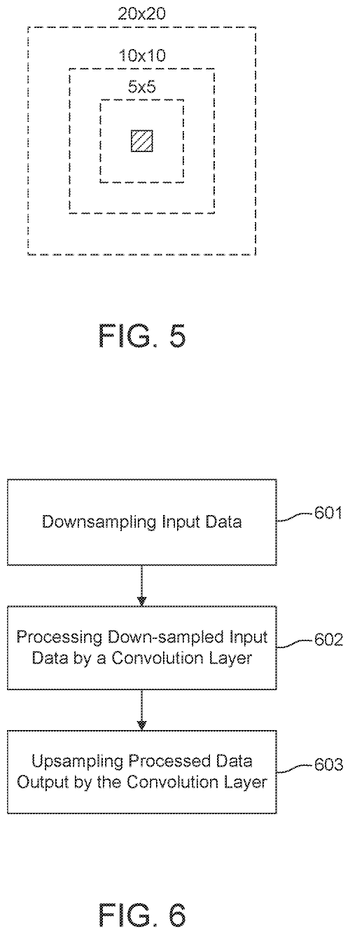

Any transform block that implements a convolution operation can be adapted to implement a multiresolution transform block. As illustrated on FIG. 6, the multi-resolution transform block comprises a down-sampling of the input data (601), for instance an input tensor, providing down-sampled input data before processing the down-sampled input data by a convolution layer (602). The down-sampling operation can be any down-sampling within the resolution of the input data or image dimension (height, width) of the input data. For instance, the down-sampling can be bilinear, bicubic, or learned down-sampling, i.e. down-sampling operations including trainable parameters such as stride convolutions or any learnable filter kernel.

The output of the convolution layer can provide a same number of channels as the input data or a distinct number of channels. The output of the convolution layer is then up-sampled (603) to the resolution of the input data.

One or more transform blocks described with FIG. 6 can be integrated in any layer of a neural network so that the layer implements a multi-resolution processing of the input data.

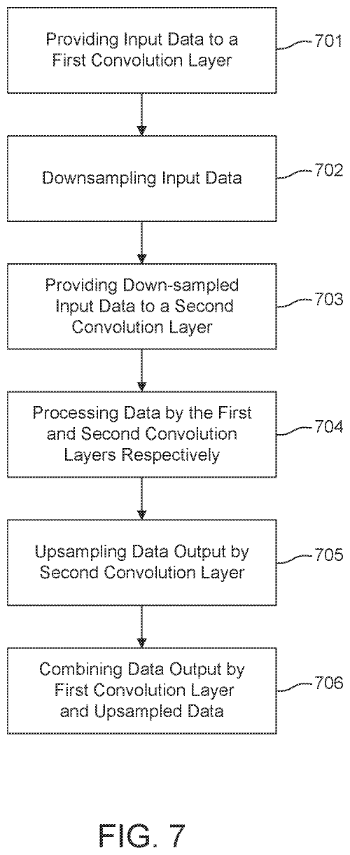

For example, steps illustrated with FIG. 6 can be integrated in a multi-resolution transform block as illustrated with FIG. 7. In this example, input data is provided to a first convolution layer (701). Input data is also down-sampled (702) by a given scale factor and provided to a second convolution layer (703). Data provided to the first and second convolution layers is processed (704) respectively by each convolution layer. The output of the second convolution layer is up-sampled (705) to the resolution of the input data and combined (706) with the output of the first convolution layer. In some variants described further below, the combination of the up-sampled data and output of the first convolution layer can be an element-wise addition or a concatenation.

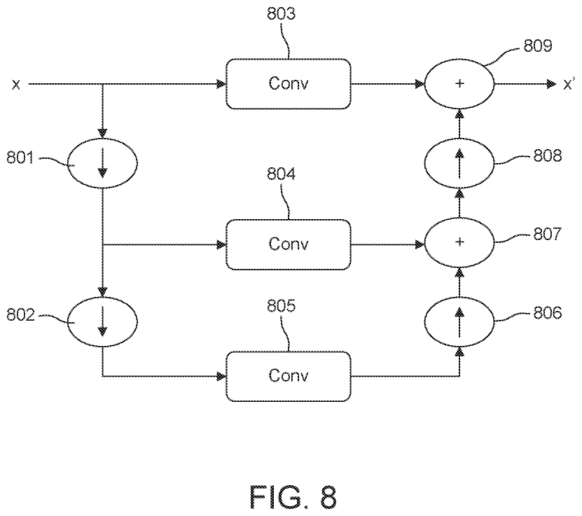

FIG. 8 illustrates a block diagram of an embodiment of a multi-resolution transform block wherein several down-samplings are applied to the input data. For an input tensor x, multiple “down-sampling” operations (801, 802) are applied (e.g. bilinear, bicubic, or learned downsampling, i.e., downsampling operations including trainable parameters such as stride convolutions or any learnable filter kernels) within the image dimensions (i.e. height and width) to produce representations of the tensor at different resolutions. On each of the resulting representations, a convolution operation (or any other operation that includes a convolution) is applied (803, 804, 805). In the example of FIG. 8, a convolution operation (803) is applied to the input tensor x which has not been down-sampled. The input tensor x is down-sampled (801) to a first resolution and a convolution operation is applied (804) to the tensor at the first resolution. The input tensor x is down-sampled (802) to a second resolution and a convolution operation is applied (805) to the tensor at the second resolution.

Finally, the results of the convolution operations are aggregated together into a single output x′ by using appropriate up-sampling and reduction operations if necessary, e.g., element wise addition in the example of FIG. 8. In the example of FIG. 8, the output of the third convolution operation (805) is up-sampled (806) to the first resolution and combined (807) with the output of the second convolution operation (804). The output of the combination (807) is up-sampled (808) to the resolution of the input data and combined (809) with the output of the first convolution operation (803). In this example, successive up-sampling operations (806, 808) are applied to the output tensor of the third convolution (805). In other variant, only one up-sampling can be applied to the output of the third convolution operation to obtain the output at the same resolution as the input data and combined with the output of the first convolution (803) and with the tensor obtained after the up-sampling (808) of the output of the second convolution operation (804).

The multi-resolution transform block provided herein is capable of substituting convolution layers or residual blocks (which contain convolutions). The advantages over a traditional convolution layer are as follows.

An effective increase in “field of vision” is obtained. Convolutions are locally windowed operations that are often limited to 3×3 or 5×5 sized windows for practical reasons. This limits the “field of vision” that a traditional convolution layer to a very small region. By applying 3×3 or 5×5 convolutions upon downscaled inputs, the transform block provided herein can “see” a much larger context without paying the price of an equivalent large-windowed convolution. For instance, a 5×5 on a 4× downscaled input has an effective window size of approximately 20×20.

A compact subspace with similar representational ability is obtained. A traditional trainable convolution of kernel size 20×20 has 400 degrees of freedom (i.e. parameters). In comparison, the method provided herein with three 5×5 kernels with 1×, 2×, and 4× kernels also produces a window size of 20×20, but the number of degrees of freedom is only 75. This means that the trained model is less prone to overfitting in comparison with the 20×20 kernel convolution. Furthermore, the method provided herein carries similar representational ability since kernel elements near the center have a high degree of freedom, and kernel elements further away inhabit a subspace of smaller effective rank per kernel element. In fact, by linearity of convolution, the method provided herein with linear downscaling can be converted into an equivalent 20×20 convolution kernel with this property.

The method provided herein provides scalable reductions in computational cost. By substituting, say, a 5×5 convolution with two 3×3s convolutions that applied at different resolutions, the number of model parameters is reduced by a factor of 18/25=0.72, and the number of multiply-accumulate (MAC) operations by (9+9/4)/25=0.45.

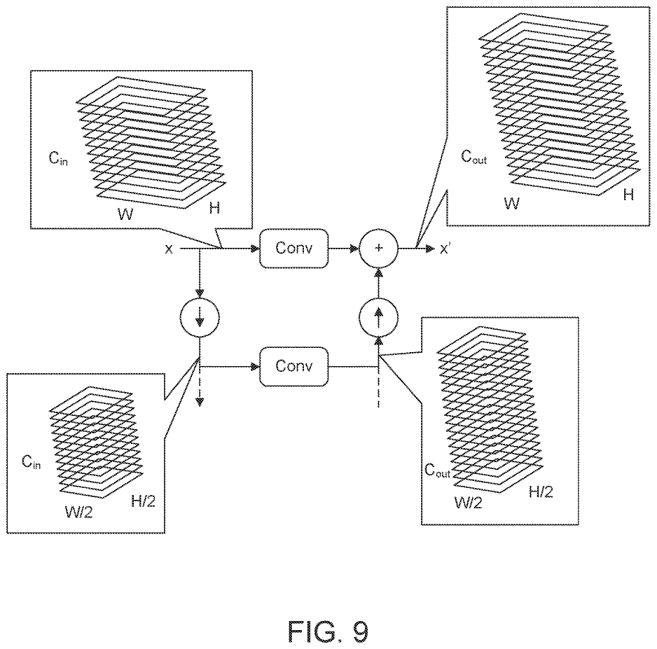

In FIG. 8, the multi-resolution transform block with multiple convolutions is described with an element-wise operation between the output tensor from the convolution at the current (input) resolution and the up-sampled tensor from a lower resolution. This combination assumes that both those tensors share the same size, including the number of channels, to be able to perform element wise addition, as described in FIG. 9 where the output tensors at different resolutions have the same number of channels Cₒᵤₜ as the final output tensor x′. In FIG. 9, the input tensor x has a number Cᵢₙ of channel, each channel having a size W×H. A downsampling is applied to the input tensor x which provides a down-sampled tensor having a same number of channel Cᵢₙ as the input tenor and size of W/2×H/2. The output of the convolution applied on the down-sampled tensor has a Cₒᵤₜ number of channels and size W/2×H/2 and the output of the convolution applied to the input tensor has a Cₒᵤₜ number of channels and size W×H. Up-sampling of the output of the convolution applied on the down-sampled tensor provides a tensor having a Cₒᵤₜ number of channels and size W×H which can then be combined with the output of the convolution applied to the input tensor x to obtain the output tensor x′ having a Cₒᵤₜ number of channels and size W×H.

In other variant, it is also possible to perform a tensor concatenation operation along the channel axis between the output tensor from the convolution at the current (input) resolution and the up-sampled tensor from the lower resolution. In that case, the number of channels of the tensor output by the convolutions can be different. It is for instance possible to design convolutions that have half the number of output channels than input channels. Then, after concatenation, the resulting tensor has the same number of output channels as the input tensor.

The embodiments described in the present document do not limit halving the output channels. Any number of output channels can be provided by the convolutions as long as the final output tensor x′ gets the desired number of output channels.

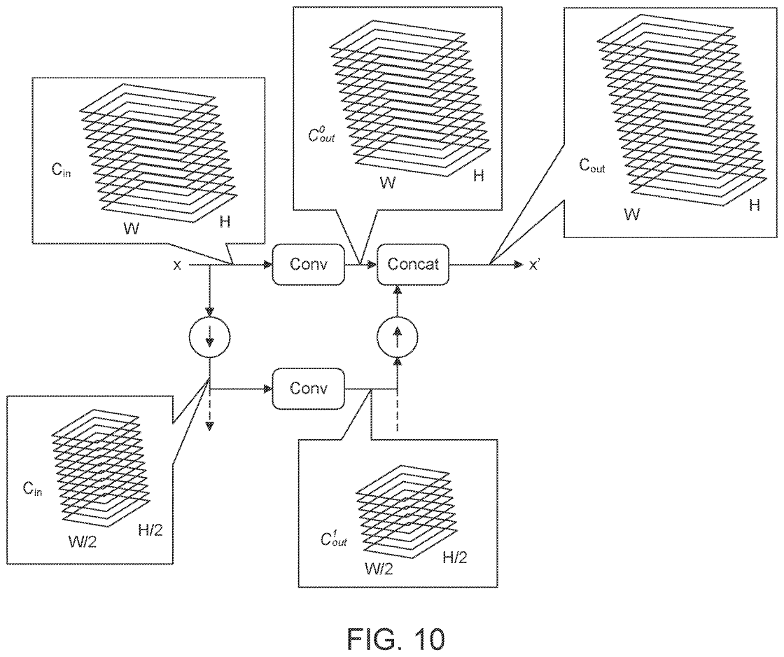

FIG. 10 depicts the first 2 levels of such an architecture. The first level takes as input the input tensor having Cᵢₙ number of channels and size W×H and the second level takes as input the down-sampled tensor having Cᵢₙ number of channels and size W/2×H/2. The convolutions of first and second levels output tensors of number of channels Cₒᵤₜ⁰ and Cₒᵤₜ¹ respectively. The number of channels Cₒᵤₜ of the final output tensor corresponds to the sum of Cₒᵤₜ⁰ and the Cₒᵤₜ¹, after concatenation (Concat in FIG. 10).

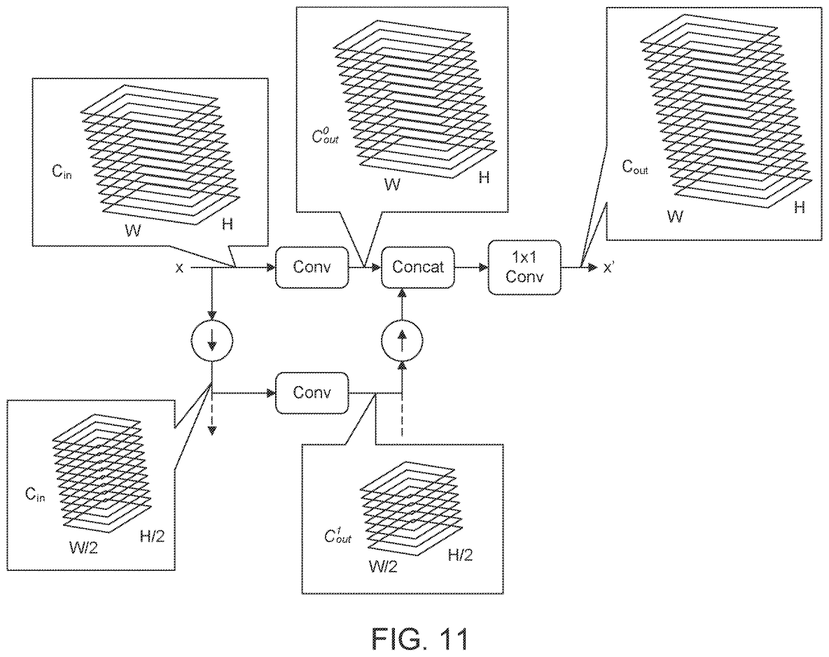

A 1×1 2D convolution can also be applied after concatenation with the desired number of output channels. This enables the system to get more flexibility in terms of output numbers of channels at different levels. The 1×1 convolution enables to adapt the number of channels after concatenations and to adapt the resulting channels as the trained parameters allows to combine the information across channels. As described in FIG. 11 for two levels, the number of channels Cₒᵤₜ for the final output tensors is not necessary the sum of Cₒᵤₜ⁰ and the Cₒᵤₜ¹ as the 1×1 convolution can output any desired number of channels.

Note that embodiments are not limited to the example of 1×1 2D convolutions. Other types of convolutions or operations can be envisioned, that allow the output tensor to get a desired number of channels, while maximizing the efficiency relative to the information contained in the output tensor.

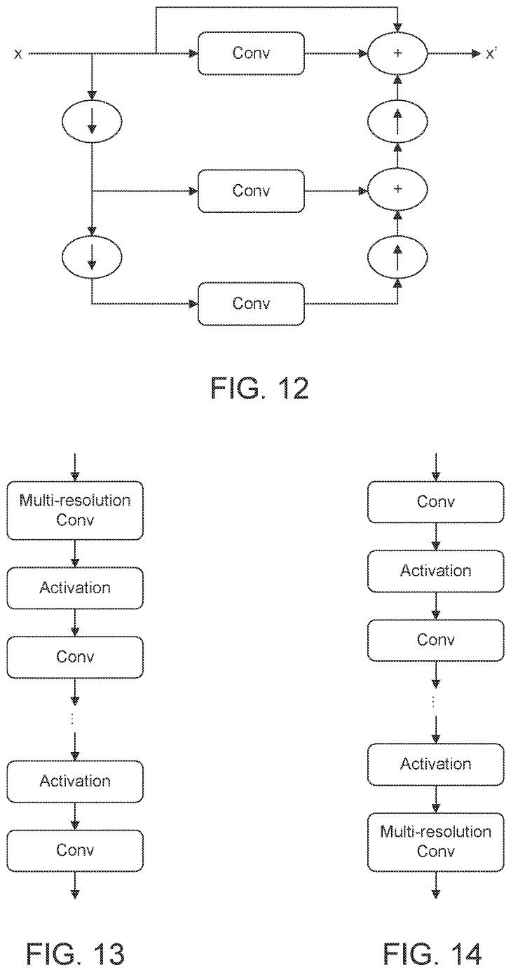

It is also to be noted the proposed multi-resolution transform block is compatible with a residual block architecture. In this variant, as illustrated on FIG. 12, a skip connection is added between the input x and the output x′. The remaining of FIG. 12 is similar to FIG. 8.

FIG. 13 illustrates a block diagram of an embodiment of an image or video encoder based on neural network using one or more multi-resolution transform block as described in the embodiments above. For instance, the encoder of FIG. 13 can replace the encoder part of the auto-encoder described in relation with FIG. 2 to 4. The encoder part is a sequence of convolutional layers with activation functions. In this variant, the first convolution layer is replaced with any one of the embodiments of the multi-resolution transform block as described above. The output of the multi-resolution transform block is provided to the subsequent layers of the neural network-based encoder.

In other variants, other convolution layers of the encoder can be replaced alone or in combination with the first layer.

FIG. 14 illustrates a block diagram of an embodiment of an image or video decoder based on neural network using one or more multi-resolution transform block as described in the embodiments above. For instance, the decoder of FIG. 14 can replace the decoder part of the auto-encoder described in relation with FIG. 2 to 4. The decoder part is a sequence of convolutional layers with activation functions. In this variant, the last convolution layer is replaced with any one of the embodiments of the multi-resolution transform block as described above. In this variant, one or more convolutions are applied at different resolutions to an output of the penultimate layer of the nerual network-based decoder.

In other variants, other convolution layers of the decoder can be replaced alone or in combination with the last layer.

Even though multi-resolution transform block is used in one or more layers of an encoder, it is not an obligation for the decoder to be a symmetric network of the encoder. In some variants, only the encoder includes one or more multi-resolution transform blocks. In other variants, both the encoder and the decoder include one or more multi-resolution transform blocks.

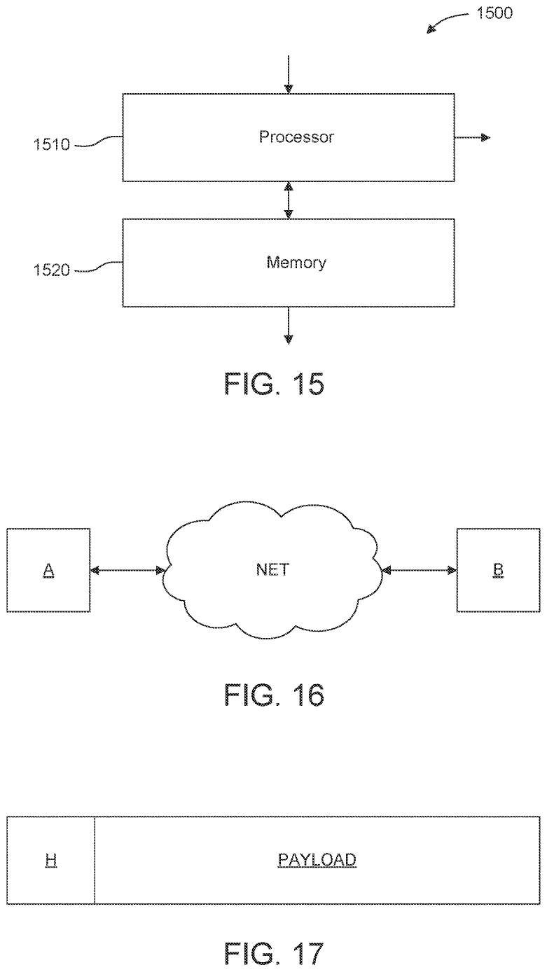

FIG. 15 shows one embodiment of an apparatus 1500 for compressing, encoding or decoding image or video using the aforementioned methods. The apparatus comprises a processor 1510 and can be interconnected to a memory 1520 through at least one port. Both the processor 1510 and the memory 1520 can also have one or more additional interconnections to external connections. The processor 1510 is also configured to either insert or receive information in a bitstream and, either compressing, encoding, or decoding using program code instructions implementing theaforementioned methods when executed by a processor. The program code to be loaded onto processor 1510 to perform the various aspects described in this application may be stored in a storage device and subsequently loaded onto memory 1520 for execution by processor 1510. The memory 1520 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1510 can be of any type appropriate to the technical environment, and can encompass one or more of microprocessors, general purpose computers, special purpose computers, digital signal processors (DSPs), processors based on a single core architecture or on a multi-core architecture, sequential or parallel architectures, specialized circuits such as Field Programmable gate arrays (FPGA), application specific circuits (ASIC), signal processing devices and other processing circuitry, as non-limiting examples.

According to an example of the present principles, illustrated in FIG. 16, in a transmission context between two remote devices A and B over a communication network NET, the device A comprises a processor in relation with memory RAM and ROM which are configured to implement a method for encoding an image or a video as described using the aforementioned methods and the device B comprises a processor in relation with memory RAM and ROM which are configured to implement a method for decoding an image or a video as described using the aforementioned methods. In accordance with an example, the network is a broadcast network, adapted to broadcast/transmit encoded image or video from device A to decoding devices including the device B.

A signal, intended to be transmitted by the device A, carries at least one bitstream comprising coded data representative of an image or a video encoded according to the methods as explained above.

FIG. 17 shows an example of the syntax of such a signal when the coded data representative of an image or a video is transmitted over a packet-based transmission protocol. Each transmitted packet P comprises a header H and a payload PAYLOAD. According to an embodiment, the payload comprises coded data representative of the image or the video encoded according to any one of the embodiments described above.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules of an image or video auto-encoder which are based on neural-network as shown in FIG. 2-4. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types.

1. (canceled)

2. A method, comprising encoding at least one part of an image comprising:
providing the at least one part of an image to a sequence of one or more convolution layers,
applying sequentially the one or more convolution layers of the sequence to the at least one part of the image, wherein at least one convolution layers of the sequence to the at least one part of the image, wherein at least one convolution layer of the one or more convolution layers is a multi-resolution convolution layer
obtaining a latent representative of the at least one part of the image from an output of the sequence of one or more convolution layers,
entropy-encoding the latent,
wherein applying the multi-resolution convolution layer comprises:
applying a first convolution to an input to the at least one multi-resolution convolution layer,
at least one down-sampling of the input to the at least one multi-resolution convolution layer to provide at least one downsampled input,
applying a second convolution to the at least one downampled input,
up-sampling an output of the second convolution to a resolution of the input to provide an upsampled output, and
combining the up-sampled output and an output of the first convolution to provide a combined output,
providing the combined output to a next convolution layer of the sequence of one or more convolution layers.

3. A method for decoding at least one part of an image comprising:
entropy-decoding a latent representative of the at least one part of the image,
providing the latent to a sequence of one or more convolution layers,
applying sequentially the one or more convolution layers of the sequence to the latent, wherein at least one convolution layer of the one or more convolution layers is a multi-resolution convolution layer,
obtaining the at least one part of the image from an output of the sequence of one or more convolution layers,
wherein applying the multi-resolution convolution layer comprises:
applying a first convolution to an input to the at least one multi-resolution convolution layer,
at least one down-sampling of the input to the at least one multi-resolution convolution layer to provide at least one downsampled input,
applying a second convolution to the at least one downampled input,
up-sampling an output of the second convolution to a resolution of the input to provide an upsampled output, and
combining the up-sampled output and an output of the first convolution to provide a combined output,
providing the combined output to a next convolution layer of the sequence of one or more convolution layers.

4. (canceled)

5. The method of claim 3, wherein the combination is an element-wise addition.

6. The method of claim 3, wherein the combination is a concatenation.

7. The method of claim 3, wherein the output of the second convolution and the output of the first convolution have a different number of channels.

8. The method of claim 3, wherein the combination comprises at least one convolution to adapt a number of channels of an output of the one-multi-resolution convolution layer.

9. The method of claim 3, wherein the multi-resolution convolution layer comprises a skip connection.

10. (canceled)

11. An apparatus for encoding at least one part of an image, the apparatus comprising one or more processors configured to:
provide the at least one part of an image to a sequence of one or more convolution layers,
apply sequentially the one or more convolution layers of the sequence to the at least one part of the image, wherein at least one convolution layer of the one or more convolution layers is a multi-resolution convolution layer,
obtain a latent representative of the at least one part of the image from an output of the sequence of one or more convolution layers,
entropy-encode the latent,
wherein applying the multi-resolution convolution layer comprises:
applying a first convolution to an input to the at least one multi-resolution convolution layer,
at least one down-sampling of the input to the at least one multi-resolution convolution layer to provide at least one downsampled input,
applying a second convolution to the at least one downampled input,
up-sampling an output of the second convolution to a resolution of the input to provide an upsampled output and
combining the up-sampled output and an output of the first convolution to provide a combined output,
providing the combined output to a next convolution layer of the sequence of one or more convolution layers.

12. An apparatus for decoding at least one part of an image, the apparatus comprising one or more processors configured to:
entropy-decode a latent representative of the at least one part of an image,
provide the latent to a sequence of one or more convolution layers,
apply sequentially the one or more convolution layers of the sequence to the latent, wherein at least one convolution layer of the one or more convolution layers is a multi-resolution convolution layer,
obtain the at least one part of the image from an output of the sequence of one or more convolution layers,
wherein applying the multi-resolution convolution layer comprises:
applying a first convolution to an input to the at least one multi-resolution convolution layer,
at least one down-sampling of the input to the at least one multi-resolution convolution layer to provide at least one downsampled input,
applying a second convolution to the at least one downampled input,
up-sampling an output of the second convolution to a resolution of the input to provide an upsampled output and
combining the up-sampled output and an output of the first convolution to provide a combined output,
providing the combined output to a next convolution layer of the sequence of one or more convolution layers.

13. (canceled)

14. The apparatus of claim 12, wherein the combination is an element-wise addition.

15. The apparatus of claim 12, wherein the combination is a concatenation.

16. The apparatus of claim 12, wherein the output of the second convolution and the output of the first convolution have a different number of channels.

17. The apparatus of claim 12, wherein the combination comprises at least one convolution to adapt a number of channels of an output of the at least one multi-resolution convolution layer.

18. The apparatus of claim 12, wherein the at least one multi-resolution convolution layer comprises a skip connection.

19. The method of claim 3, wherein the sequence of one or more convolution layers is part of a neural network, which is part of an auto-encoder.

20. The apparatus of claim 12, wherein the sequence of one or more convolution layers is part of a neural network, which is part of an auto-encoder.

21-24. (canceled)

25. A computer readable storage medium having stored thereon instructions for causing one or more processors to perform the method of claim 3.

26. (canceled)

27. A device comprising:
an apparatus according to claim 12; and
at least one of (i) an antenna configured to receive a signal, the signal including a bitstream representative of at least one part of an image encoded according to claim 2, (ii) a band limiter configured to limit the received signal to a band of frequencies that includes the bitstream, or (iii) a display configured to display a reconstructed version of the at least one part of an image.

28. (canceled)

29. The apparatus of claim 11, wherein the multi-resolution convolution layer is a first layer of the sequence of one or more convolution layers.

30. The apparatus of claim 12, wherein the multi-resolution convolution layer is a last layer of the sequence of one or more convolution layers.
